(19) United States
(12) Patent Application Publication
(10) Pub. No.: US 2011/0228265 A1
(43) Pub. Date: Sep. 22, 2011

(54) PROCESS FOR THE DETERMINATION OF THE SOLID/LIQUID PHASE

(75) Inventors: Ivana Durickovic, Metz (FR); Mario Marchetti, Liverdun (FR); Rémy Claverie-Rospide, Pompey (FR); Jean Livet, Champenoux (FR); Patrice Bourson, Norroy-Le-Veneur (FR); Marc Fontana, Semecourt (FR); Jean-Marie Chassot, Paris (FR)

(73) Assignee: UNIVERSITE DE METZ PAUL VERLAINE, METZ CEDEX 01 (FR)

(21) Appl. No.: 13/124,006

(22) PCT Filed: Oct. 16, 2009
(86) PCT No.: PCT/FR09/51976

§ 371 Date: May 31, 2011

(30) Foreign Application Priority Data
Oct. 17, 2008 (FR) 0857090

(51) Int. Cl. G01J 3/44

(52) U.S. Cl. 356/301

(57) ABSTRACT

A method of determining the solid/liquid phase of an aqueous solution, characterized in that it comprises the following steps: a) subjecting said aqueous solution to a beam of photons; b) recording the Raman spectrum of the photons scattered by said solution in the wave number range between 2500 cm⁻¹ to 4000 cm⁻¹; and c) processing said recording in order to deduce therefrom the solid/liquid phase of said aqueous solution.

This is a 371 national phase application of PCT/FR2009/051976 filed 16 Oct. 2009, claiming priority to French Patent Application No. 0857090 filed 17 Oct. 2008, the contents of which are incorporated herein by reference.

### FIELD OF THE INVENTION

The present invention provides a method of determining whether an aqueous solution is in the solid or the liquid phase.

To be more precise, the present invention relates to a method of determining the liquid or solid state of a substance containing at least a possibly minimal quantity of water.

### BACKGROUND OF THE INVENTION

There are very numerous and highly diverse situations in which it is important to know whether a substance containing at least a minimum quantity of water is in the solid state or the liquid state or, to be more precise, whether the portion of water contained in the substance is in the liquid or the solid state, or possibly whether that water is in a transition state between the solid state and the liquid state.

One field in which making this determination is particularly important is that of monitoring the state of roads during winter.

It is well known that, during periods in which below-freezing temperatures may occur, the competent services responsible for the roads make use of aqueous solutions of sodium chloride at higher or lower concentration, or, more rarely, aqueous solutions of other salts.

After this spreading, it is important for the competent services to be able to check periodically that the aqueous solution remains in liquid form in order to prevent the risk of ice or frost forming on the road.

It goes without saying that the risk of frost or ice forming varies greatly from one road area to another. Thus, it is very important, especially for road safety, to detect whether the spread aqueous solution has locally changed to the solid state.

Clearly, manual or visual checking for the possible occurrence of such a situation is laborious, costly, and random.

Checks that are purely statistical or too localized in the geographical sense run the risk of leaving portions of the road that are very dangerous.

Furthermore, when those checks have to be carried out in poor light, visual checking is somewhat ineffective.

Thus, there exists a real need for a technique, particularly, but not exclusively, for checking the state of roads in winter, making it possible to determine the solid or liquid state of a substance containing water, in particular, by means that do not rely on visual observation, manual checking, or making a measurement that is geographically too localized or not representative of a route.

### SUMMARY OF THE INVENTION

The first object of the invention is to provide a method of determining whether an aqueous solution, or, more generally, a substance containing water, is in the solid or the liquid phase and to provide a method that satisfies the conditions set out above.

To achieve this object, the method of the invention for determining the solid/liquid phase of an aqueous solution is characterized in that it comprises the following steps:

a) subjecting said aqueous solution to a beam of photons;

b) recording the Raman spectrum of the photons scattered by said solution in the wave number range 2500 per centimeter (cm⁻¹) to 4000 cm⁻¹; and
c) processing said recording in order to deduce therefrom the solid/liquid phase of said aqueous solution.

Clearly, the means for implementing the method comprise only a source of photons, a Raman spectrometer, and information processing means.

As a result of this, there need not be any contact between the means for implementing the method and the substance of phase that is being determined.

Another result of this is that all of the means for implementing the method may be moving relative to the substance to be checked or relative to a support on which the substance is located.

A final result of this is that such determination can be undertaken regardless of the conditions external to the substance.

In the situation referred to above of checking the state of a road, all of the necessary means may be onboard a vehicle moving along the road.

When checking frozen food products, the food products may be located on a conveyor belt, or the like, with the means for implementing the method being stationary.

In a preferred implementation of the method, to implement the step c):
the curve of Raman intensity as a function of wave number in said range is defined; and
the solid/liquid phase of said aqueous solution is deduced on the basis of at least one difference between the Raman intensities in the sub-range of wave numbers corresponding to symmetrical stretching of the OH bonds of the aqueous solution and the sub-range of wave numbers corresponding to asymmetrical stretching of the OH bonds of the aqueous solution.

In one implementation of the method, to implement the step c):
the curve of Raman intensity as a function of wave number in said range is defined;
two specific wave numbers are determined for said solution;
the ratio between magnitudes representative of the points on the Raman spectrum corresponding to the two specific wave numbers is calculated to obtain a phase ratio for said solution; and
said phase ratio is compared to a reference curve of said phase ratio as a function of temperature.

In a first implementation of the method, the phase determination method is characterized in that, in order to determine the reference curve of said phase ratio:
the curves of Raman intensities of said solution at different temperatures as a function of wave numbers in the range concerned are recorded;
the Raman intensities corresponding to the two specific wave numbers are determined for each curve and the ratio of these intensities is calculated so as to obtain a reference phase ratio for each temperature; and
the curve of said reference phase ratios as a function of temperature is defined.

In a second implementation of the method, the phase determination method is characterized in that in order to determine the reference curve of said phase ratio:
the points of the curve corresponding to said two specific values are determined for each curve, an area defined by the curve in the vicinity of said point is calculated, and the ratio of these areas is calculated so as to obtain a reference phase ratio for each temperature; and
the curve of said reference phase ratios as a function of temperature is defined.

The phase determination method is preferably characterized in that said two specific wave numbers are chosen so that one of said wave numbers is chosen in the sub-range of wave numbers corresponding to symmetrical stretching of the OH bonds and the other in the sub-range of wave numbers corresponding to asymmetrical stretching of the OH bonds.

The method may be applied to a large number of aqueous solutions including, in particular, a chloride, an acetate, a formate, urea, or a mixture of some or all of these salts.

More generally, the invention applies to any substance producing an anion when it is dissolved in water.

A second object of the invention is to provide the application or use of the above-defined method in its different variants for determining the state of a road.

The benefit of such a method of checking is explained above.

A third object of the invention is to provide the application or use of the above-defined method to checking the frozen state of food products, notably, but not exclusively, food products producing brine.

By checking the solid or liquid phase of the water contained in the food product, it is possible to determine its frozen state. This is made economically and technically possible, in particular, by the fact that the method is non-destructive and may be effected through the packaging of the food product.

A fourth object of the invention is to provide the application or use of the method for the purpose of detecting the occurrence or the presence of ice in a pipe transporting a substance containing at least a fraction of water.

### BRIEF DESCRIPTION OF THE DRAWINGS

Other features and advantages of the invention become more apparent on reading the following description of several embodiments of the invention given as non-limiting examples.

The description refers to the appended figures, in which:

FIG. 1 is a curve showing an example of a Raman spectrum for an aqueous solution;

FIG. 2 shows an example of a reference curve used in the method of the invention;

FIG. 3 shows three reference curves for pure water determined for different wave numbers;

FIG. 4 shows a reference curve for a 60 grams per Liter (g/L) NaCl solution;

FIG. 5 shows an example of equipment for implementing the method of the invention;

FIG. 5A shows processing circuits used in said equipment; and

FIG. 6 shows Raman spectra for aqueous solutions of sodium chloride, potassium acetate, and urea in the liquid and solid phases.

### DETAILED DESCRIPTION

As explained above, the method of the invention uses Raman spectrometry.

This technique is well known in itself and thus need not be described in detail.

It suffices to outline its general principle.

When a sample is subjected to a monochromatic electromagnetic wave, a small part of the light is scattered.

Frequency analysis of the scattered light shows up a component of the same wavelength as the incident light (elastic scattering) and a component comprising wavelengths different from the incident beam (inelastic scattering).

It is this second component that is used in Raman spectrometry. The Raman spectrum of the scattered beam is characteristic of the medium to which the electromagnetic beam was applied.

The method of determining the solid or liquid phase of a completely identified aqueous solution is described below.

Implementing the method includes a preliminary step of constructing a reference curve followed by a step of determining the real liquid or solid phase of the substance to be tested.

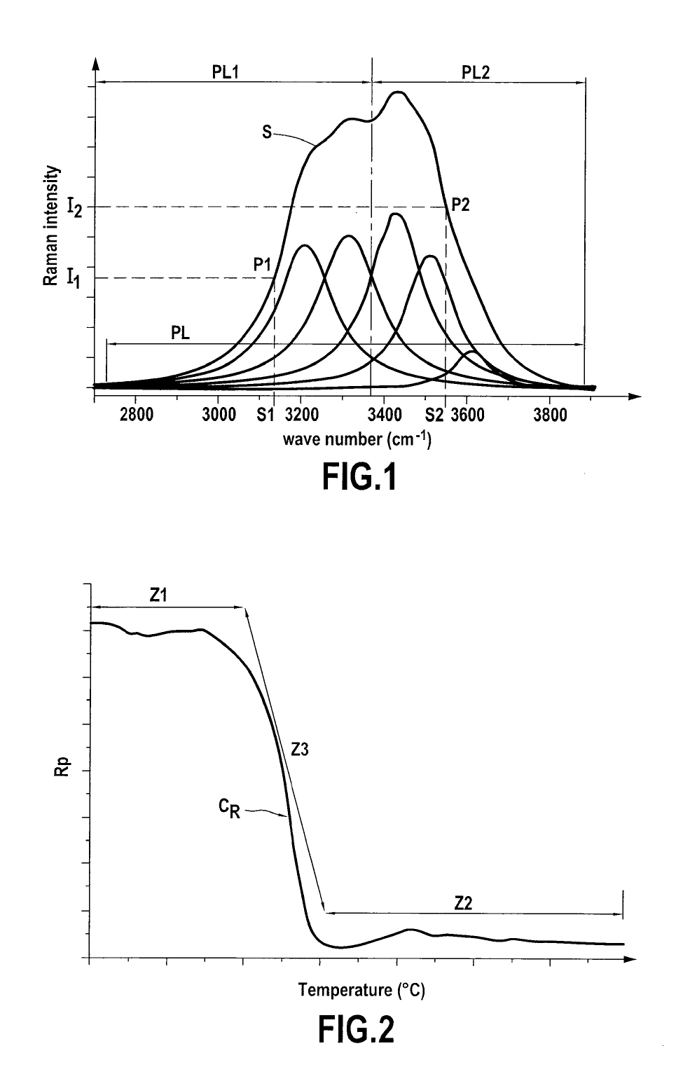

FIG. 1 shows a Raman spectrum for a solution of phase that is to be determined at a given temperature; the abscissa axis represents the wave number and the ordinate axis the Raman intensity.

The total range PL of wave numbers, which extends from 2500 cm⁻¹ to 4000 cm⁻¹, may be divided into two sub-ranges PL₁ and PL₂ respectively corresponding to symmetrical stretching of the OH bonds of water, which is representative of the solid state, and asymmetrical stretching of the OH bonds of water, which corresponds to the liquid state.

A first wave number S₁ in the sub-range P₁ and a second value S₂ in the sub-range P₂ are chosen.

The discrimination that can be made based on the reference curve is improved by choosing the pair of wave numbers S₁ and S₂ appropriately.

To the wave numbers S₁ and S₂, there correspond points P₁ and P₂ on the curve S. There is associated with each point P₁ or P₂ a magnitude representative of its Raman intensity. This may be the intensity itself I₁ or I₂, or the area A₁ or A₂ between the curve S and the abscissa axis for a limited curve portion around the point P₁ or P₂. The phase ratio Rₚ between these representative magnitudes is then calculated.

$${R}_{P} ( T ) = \frac{{I}_{1} ( T )}{{I}_{2} ( T )} or {R}_{P} ( T ) = \frac{{A}_{1} ( T )}{{A}_{2} ( T )}$$

The same operation is effected for different temperatures in the range of temperatures concerned.

A reference curve C_{R}(T) may be drawn by plotting temperature T along the abscissa axis and the phase ratios Rₚ up the ordinate axis.

FIG. 2 shows an example of a reference curve C_{R} for an aqueous solution of phase that is to be determined.

In this figure, it can be seen that the curve C_{R} includes a first part Z₁ corresponding to the solid state, a second part Z₂ corresponding to the liquid state, and an intermediate portion Z₃ corresponding to the solid/liquid transition.

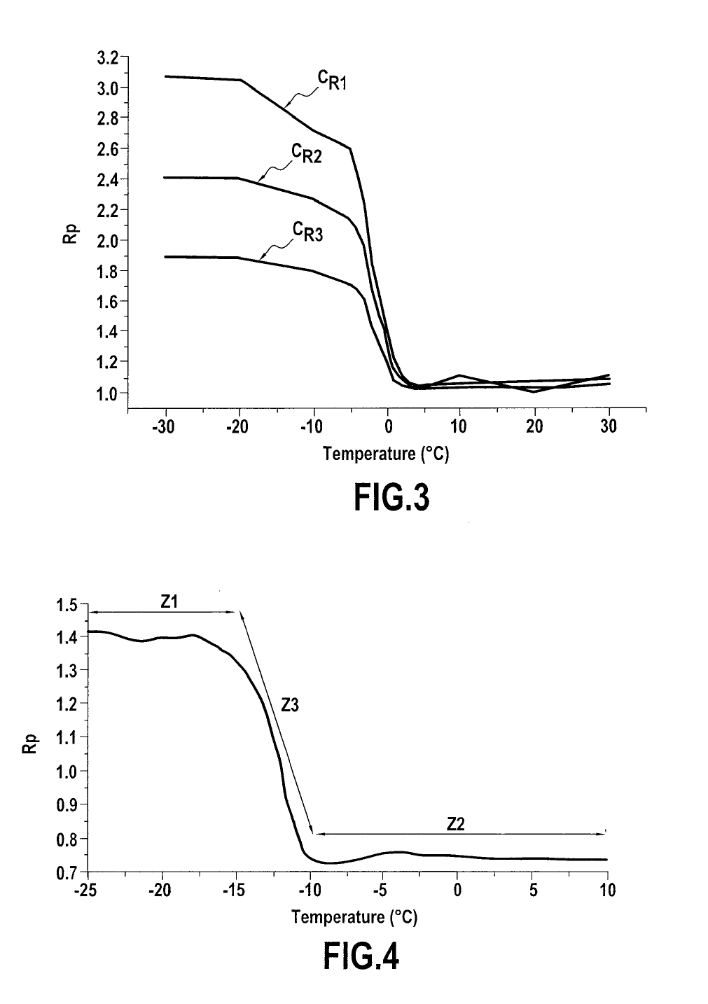

FIG. 3 shows reference curves C_{R1}, C_{R2}, C_{R3} corresponding to the same aqueous solution in the particular situation of water only.

For the curve C_{R1}, Rₚ was determined by calculating the ratio of the areas A₁ (3,080 cm⁻¹ to 3,200 cm⁻¹) and A₂ (3,300 cm⁻¹-3,420 cm⁻¹). For the curve C_{R2}, Rₚ was calculated from the areas A₁ (3,080 cm⁻¹-3,200 cm⁻¹) and A₂ (3,350 cm⁻¹-3,500 cm⁻¹).

For the curve C_{R3}, Rₚ was calculated from the intensities I₁ and 1₂ respectively corresponding to S₁=3,135 cm⁻¹ and S₂=3,425 cm⁻¹.

Note that whatever method is used to determine the reference curve, all the curves obtained are of the same general shape.

After establishing the reference curves C_{R} corresponding to the aqueous solution to be tested and the range of temperatures concerned, the liquid or solid phase of the aqueous solution is determined in situ by recording the Raman spectrum for that solution. From the recording of that spectrum, the phase ratio Rₚ specific to the solution is calculated, naturally while using the same parameters as were used to establish the reference curve C_{R} (same values of S₁ and S₂, use of intensities or areas).

By plotting the value of the phase ratio Rₚ determined in this way on the reference curve C_{R}, it is possible to deduce whether the aqueous solution is in the liquid phase, the solid phase, or the transition phase.

In the above description, the different steps of the method of determining the phase of an aqueous solution are explained.

The method includes a preliminary step of preparing the reference curve C_{R} and a measurement step as such linked to the example of an aqueous solution of phase that is to be determined.

The preliminary step does not require access to the example to be tested. It suffices to have available a sample of aqueous solution identical to the solution that is to be tested.

Where the determination step as such is concerned, this requires only acquisition of the Raman spectrum of the sample for testing followed by mathematical and logical processing of the acquired spectrum. This therefore requires no contact with the aqueous solution for testing, nor any particular conditioning of the solution.

The method of the invention is therefore highly flexible in use.

By way of non-limiting example, there follows a description of equipment for determining the phase of an aqueous solution of de-icing substances (for example, NaCl) spread over a road.

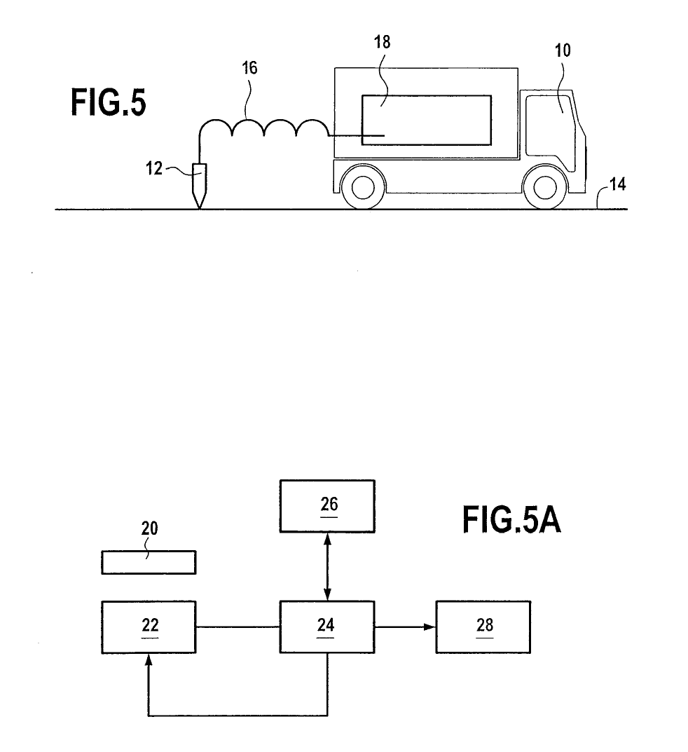

As shown in FIG. 5, the equipment comprises a vehicle 10 having a Raman probe 12 mounted on its outside and directed toward the road 14 on which the aqueous solution to be tested has been spread. The probe 12 is connected by optical fibers 16 to instrumentation 18.

The instrumentation may comprise a laser source 20 and a Raman spectrometer 22 connected to the optical fibers 16. The spectrometer 22 sends information to a processor unit 24, which information corresponds to the successively established Raman spectra. The information capture instants may be generated automatically by the processor unit 24.

The processor unit 24 is associated with a memory 26 for storing data relating to the reference curve C_{R}, the wave numbers S₁ and S₂, and software for processing received Raman spectra.

For each received spectrum, a phase ratio Rₚ is calculated and the reference curve is compared to the calculated phase ratio Rₚ in order to deduce the phase of the aqueous solution. A display screen 28 enables the operator to view the results. These results may equally constitute control data for another device or method and may thus feed into the control loop of those devices or methods.

Of course, uses of the method may be envisaged other than those referred to above. It suffices that they rely on determining the solid or liquid phase of a substance, in particular an aqueous solution, provided it contains a sufficient quantity of water.

As indicated above, the method may be applied to very numerous salts in aqueous solution in the sense defined above.

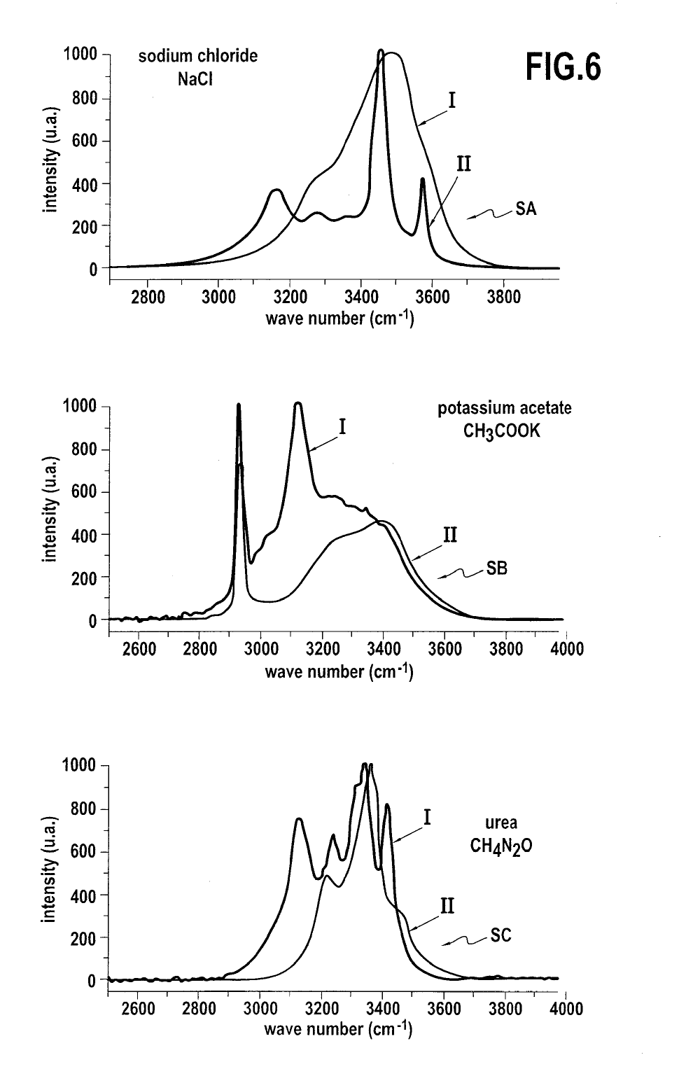

To illustrate these possibilities, FIG. 6 shows three Raman spectra SA, SB, and SC, respectively corresponding to sodium chloride, potassium acetate, and urea. For each salt there is given an example of a Raman spectrum I in the liquid state and an example of a Raman spectrum II in the solid state.

1. A method of determining the solid/liquid phase of an aqueous solution, comprising the following steps:
a) subjecting said aqueous solution to a beam of photons;
b) recording the Raman spectrum of the photons scattered by said solution in the wave number range 2500 cm⁻¹ to 4000 cm⁻¹; and
c) processing said recording in order to deduce therefrom the solid/liquid phase of said aqueous solution.

2. A phase determination method according to claim 1, wherein to implement the step c):
the curve of Raman intensity as a function of wave number in said range is defined; and
the solid/liquid phase of said aqueous solution is deduced on the basis of at least one difference between the Raman intensities in the sub-range of wave numbers corresponding to symmetrical stretching of the OH bonds of the aqueous solution and the sub-range of wave numbers corresponding to asymmetrical stretching of the OH bonds of the aqueous solution.

3. A phase determination method according to claim 1, wherein to implement the step c):
the curve of Raman intensity as a function of wave number in said range is defined;
two specific wave numbers are determined for said solution;
the ratio between magnitudes representative of the points on the Raman spectrum corresponding to the two specific wave numbers is calculated to obtain a phase ratio for said solution; and
said phase ratio is compared to a reference curve of said phase ratio as a function of temperature.

4. A phase determination method according to claim 3, wherein to determine the reference curve of said phase ratio:
the curves of Raman intensities of said solution at different temperatures as a function of the wave numbers in the range concerned are recorded;
the Raman intensities corresponding to the two specific wave numbers are determined for each curve and the ratio of these intensities is calculated so as to obtain a reference phase ratio for each temperature; and
the curve of said reference phase ratios as a function of temperature is defined.

5. A phase determination method according to claim 3, wherein in order to determine the reference curve of said phase ratio:
the points of the curve corresponding to said two specific values are determined for each curve, an area defined by the curve in the vicinity of said point is calculated, and the ratio of these areas is calculated so as to obtain a reference phase ratio for each temperature; and
the curve of said reference phase ratios as a function of temperature is defined.

6. A phase determination method according to claim 3, wherein said two specific wave numbers are chosen so that one of said wave numbers is chosen in the sub-range of wave numbers corresponding to symmetrical stretching of the OH bonds and the other in the sub-range of wave numbers corresponding to asymmetrical stretching of the OH bonds.

7. A phase determination method according to claim 1, wherein said aqueous solution contains a salt chosen from the group comprising chlorides, acetates, formates, urea, or a mixture of said salts.

8. A phase determination method according to claim 1, wherein said aqueous solution consists of any substance producing an anion when dissolved in water.

9. The application of the method according to claim 1 to detecting the presence on a road of water and its liquid or solid phase.

10. The application of the method according to claim 1 to checking the frozen state of food products.

11. The application of the method according to claim 1 to detecting the appearance or the presence of ice in a pipe transporting a substance containing at least a fraction of water.

12. A phase determination method according to claim 2, wherein to implement the step c):
the curve of Raman intensity as a function of wave number in said range is defined;
two specific wave numbers are determined for said solution;
the ratio between magnitudes representative of the points on the Raman spectrum corresponding to the two specific wave numbers is calculated to obtain a phase ratio for said solution; and
said phase ratio is compared to a reference curve of said phase ratio as a function of temperature.

13. A phase determination method according to claim 12, wherein to determine the reference curve of said phase ratio:
the curves of Raman intensities of said solution at different temperatures as a function of the wave numbers in the range concerned are recorded;
the Raman intensities corresponding to the two specific wave numbers are determined for each curve, and the ratio of these intensities is calculated so as to obtain a reference phase ratio for each temperature; and
the curve of said reference phase ratios as a function of temperature is defined.

14. A phase determination method according to claim 12, wherein in order to determine the reference curve of said phase ratio:
the points of the curve corresponding to said two specific values are determined for each curve, an area defined by the curve in the vicinity of said point is calculated, and the ratio of these areas is calculated so as to obtain a reference phase ratio for each temperature; and
the curve of said reference phase ratios as a function of temperature is defined.

15. The application of the method according to claim 2 to detecting the presence on a road of water and its liquid or solid phase.

16. The application of the method according to claim 2 to checking the frozen state of food products.

17. The application of the method according to claim 2 to detecting the appearance or the presence of ice in a pipe transporting a substance containing at least a fraction of water.
